(19) United States
(12) Patent Application Publication
(10) Pub. No.: US 2009/0066531 A1
(43) Pub. Date: Mar. 12, 2009

(54) DEVICE FOR ASSEMBLING TWO STRUCTURAL ELEMENTS

(75) Inventors: Mohieddine Boubtane, Seyssinet-Pariset (FR); Jean-Jacques Legat, Colombe (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/279,922

(22) PCT Filed: Jan. 25, 2007
(86) PCT No.: PCT/EP2007/000621

§ 371 Date: Aug. 19, 2008

(30) Foreign Application Priority Data
Mar. 3, 2006 (FR) 0601900

(51) Int. Cl. G08B 21/00

(52) U.S. Cl. 340/687

(57) ABSTRACT

A device (10) for assembling two structural elements comprising a radio frequency tag (30) incorporating an antenna for transmitting data concerning the status of the assembly to an external control unit. It further comprises a metallic element (31) taking up a first position before the structural elements are assembled, and a second position after said assembly. The metallic element (31) interferes in one of said positions with the transmission and/or reception of the antenna of the radio frequency tag (30), and does not interfere with said transmission and/or said reception in the other position.

### CROSS-REFERENCE TO RELATED APPLICATION

This application is a U.S. National Phase Patent Application based on International Application Serial No. PCT/EP2007/000621 filed Jan. 25, 2007, the disclosure of which is hereby explicitly incorporated by reference herein.

### BACKGROUND OF THE INVENTION

1. Field of the Invention

The present invention relates to a device for assembling two structural elements, the assembly device including a radiofrequency tag incorporating an antenna for transmitting data relating to the status of the assembly to an external control unit.

2. Description of the Related Art

Such assembly devices are already known in the prior art. One example of such a device is described by German Utility Model DE 20 2004 002 116 U1, which proposes a connecting device for tubular elements in which the correct insertion of the male joining piece in the female joining piece closes a circuit, preferentially electrical. To this end, the male and/or female joining pieces may contain electrical conductors or may be constructed directly of conducting material. After correct insertion of the male joining piece, the conductors on the male piece, on the female piece, on both pieces simultaneously or, optionally, on the locking mechanism, create a continuous conductor. This continuity results in a change of status that may be transmitted to a control unit, located remotely, through a transponder and a radiofrequency antenna. In some embodiments, it is the discontinuity of the conductor that creates the change in status after correct insertion of the male piece.

Another example of an assembly device of the type used for connecting tubular elements is described in patent application US2005/0063125. This device comprises a male joining piece, a female joining piece, and a locking mechanism, constructed in such a way that the locking mechanism can only be closed when the male joining piece is fully inserted into the female joining piece. This type of device is designed to ensure that the male piece is correctly inserted in the female piece before the locking mechanism moves into the closed position. The movement of the locking mechanism into closed position results in the closure of an electrical switch implanted in a resonant circuit in which a radiofrequency tag is inserted. The amplitude of the signal emitted by the radiofrequency tag antenna varies based on the resonance. Thus, the signal received by the external control unit make it possible to determine, remotely, whether the device is simultaneously assembled and locked.

However, these assembly devices are not entirely satisfactory because they require the installation of electrical conductors and/or switches on the parts making up the devices. This requirement introduces risks associated with wear over time, which may jeopardize the reliability of the devices. Extreme conditions (acidity, humidity, extreme temperatures) may lead to false contacts and short-circuits, for example due to corrosion of the conductors and/or switches.

Moreover, these prior art devices are complex both in design and to produce, making them very costly. This is a significant factor, given that these devices are generally mass-produced.

### SUMMARY OF THE INVENTION

The present invention provides a device that overcomes these prior disadvantages, in particular by providing a low-cost assembly device of simple design offering improved reliability.

According to the invention, this object is attained by the inclusion of a metallic element that assumes a first position before assembly of the structural elements, and a second position after said assembly; said metallic element interfering with the transmission and/or reception of the radiofrequency tag antenna in one of said positions, and not interfering with said transmission and/or said reception in the other position.

The metallic element according to the invention makes it possible to simply and reliably permit or preclude communications between the external control unit and the radiofrequency antenna of the assembly device based on whether said device is assembled or not assembled.

In one form thereof, the present invention provides a device for assembling two structural elements, the assembly device including a radiofrequency tag incorporating an antenna for transmitting data concerning the status of the assembly to an external control unit, characterized in that it contains a metallic element that takes up a first position before the structural elements are assembled, and a second position after the assembly, the metallic element interfering in one of the positions with the transmission and/or reception of the antenna of the radiofrequency tag, and not interfering with the transmission and/or reception in the other position.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of one embodiment of an assembly device according to the present invention;

FIG. 2 is a partial front view of the device in FIG. 1, showing a partial cross-section along the discontinuous cross-sectional plane A-A′ indicated in FIG. 6;

FIG. 3 is a partial perspective view of the device shown in FIG. 1, in the open position, showing a partial cross-section along the discontinuous cross-sectional plane A-A′ indicated in FIG. 6;

FIG. 4 is a partial perspective view of the device shown in FIG. 1, in the closed position, showing a partial cross-section along the discontinuous cross-sectional plane A-A′ indicated in FIG. 6;

FIG. 5 is a partial top view of the device shown in FIG. 1, in the non assembled state;

FIG. 6 is a partial top view of the device shown in FIG. 1, in the assembled state; and

FIG. 7 is a perspective view of the metallic element according to the invention used in the device shown in FIG. 1.

Corresponding reference characters indicate corresponding parts throughout the several views. Although the exemplification set out herein illustrates an embodiment of the invention, the embodiment disclosed below is not intended to be exhaustive or to be construed as limiting the scope of the invention to the precise form disclosed.

### DETAILED DESCRIPTION

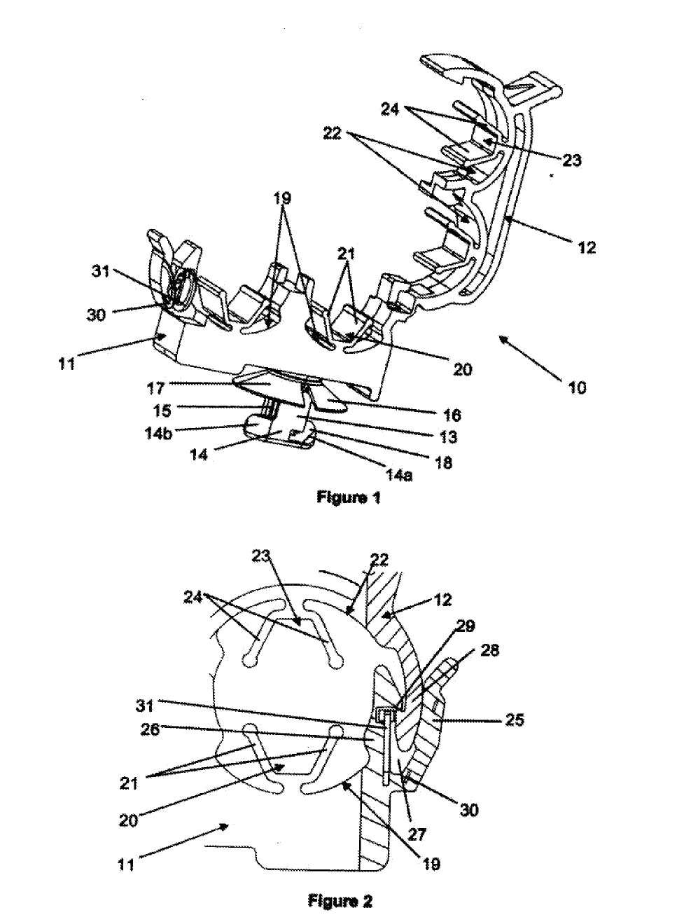

FIG. 1 shows a device (10) for assembling two durite type tubes (not shown), on a support (not shown). The assembly device (10) has a generally rectangular base (11), to be interlocked with the support, and a cover (12), to be brought down and attached to the base (11) for clamping the tubes into place.

The lower face of the base (11), which is designed to come into contact with the support, includes means of attachment to the support comprised of an elongated shank (13) perpendicular to said lower face. On the end opposite to the lower face of the base (11), the elongated shank (13) has a foot (14) of oblong cross-section with a first external extremity (14a) and a second external extremity (14b).

At the juncture (15) between the foot (14) and the base (11), a transverse flange (16), consisting of a truncated partition (17), delimiting a circle of smaller diameter and a circle of larger diameter, the smaller circle being attached at the juncture (15) and the larger circle being positioned above the proximal extremity of the foot (14). The “proximal extremity of the foot” (14) refers to the end of the foot attached to the juncture (15). The other end of the foot (14) is referred to as the “distal extremity.” The transverse flange (16) thus forms a truncated partition widening out from the juncture (15) in the proximity of the base (11) toward the foot (14).

Additionally, the transverse flange (16) is composed of an elastic material allowing its deformation under stress pushing the larger diameter circle closer toward the base (11).

The support, whose thickness is slightly greater than the axial displacement between the foot (14) and the transverse flange (16), has an opening of oblong cross-section corresponding to the cross-section of the foot (14), but with slightly greater dimensions for assembly clearance. This opening configuration allows the foot (14) to be introduced in said opening starting with its distal extremity and ending with its proximal extremity, until the support comes into contact with the transverse flange (16), which acts as a mobile axial stop.

After this, the user must apply a quarter-turn rotation to the assembly device (10). This quarter turn rotation attaches the assembly device (10) to the support. The support is thus maintained in position between the external extremities (14a, 14b) of the foot (14) and the transverse flange (16).

In the shown embodiment, the assembly device (10) comprises means of clamping that automatically draw together the support and base (11) as the device is rotated. The clamping means consist of a ramp (18) in each external extremity (14a, 14b) of the foot (14), which press against the perimeter of the opening of the support during assembly.

Thus, during the mounting of the device (10) on the support, the support moves toward the base (11). As it does so, the support forces the larger circle of the transverse flange (16) to come closer with respect to its natural position to the base (11), ensuring the clamping of the support for greater stability.

The upper face of the base (11) comprises two lower transversal semi cylindrical cavities (19), constructed according to the width of the base (11). The bottom of each lower transversal cavity (19) has a lower receptacle (20) for receiving a tube to be assembled on the support. Each lower receptacle (20) is formed by two converging sides (21) arranged in the shape of a V.

The cover (12) pivots with respect to one end of the base (11) along an axis parallel to the width of the base (11). Complementarily, the lower face of the cover (12) contains two upper transversal semi cylindrical cavities (22) constructed according to the width of the cover (12). The bottom of each upper transversal semi cylindrical cavity (22) has an upper receptacle (23) for receiving a tube to be assembled on the support. Each upper receptacle (23) is formed by two converging sides (24) arranged in the shape of a V. The upper receptacles (23) are such that after the cover (12) is brought down against the base (11), each upper receptacle (23) is situated straight over a lower receptacle (20).

FIG. 1 shows the assembly device (10) in the non assembled state, that is, in a configuration in which the cover (12) is lifted away from the base (11). In this position, the operator can easily insert the tubes to be assembled on the support into the lower receptacles (20). In the assembled state, that is, after the cover (12) is brought down against the base (11), the tubes are clamped into position between the upper and lower receptacles (20, 23).

FIG. 2 shows in greater detail the clipping mechanism used to maintain the assembly device (10) in the assembled state by holding the cover (12) against the base (11). From the edge of the base (11) opposite the hinge joint of the cover (12), a protruding tab (25) extends parallel to the outside rim (26) of the corresponding lower transversal cavity (19). The protruding tab (25) and the outside rim (26) define between them a transverse slit (27), open toward the top, extending along the width of the base (11). A clipping hook (28) is provided at the end of the cover (12) in the external rim of the corresponding upper transversal cavity (22). The clipping hook (28) is designed to clip into said transverse slit (27) to mate with a hook retaining face (29) positioned halfway up the outside rim (26) and turned toward the bottom of the transverse slit (27).

When the clipping hook (28) is inserted into the transverse slit (27) by bringing the cover (12) against the base (11), the clipping hook (28) flexes and initially separates the protruding tab (25) by flexion. When it reaches the end of a given insertion course, the clipping hook (28) makes contact with the retaining face (29) by elastic recoil. A clamping force resulting from the elastic recoil of the protruding tab (25) maintains the clipping hook (28) against the retaining face (29). Once clipped, the clipping hook (28) can only be released by manual separating pressure against the end of the protruding tab (25).

The assembly device (10) also comprises a ring-shaped radiofrequency tag (30), visible in cross section in FIGS. 2 to 6. The purpose of the radiofrequency tag (30) is to transmit data concerning the assembled or non assembled status of the assembly device (10) to an external control unit. As a general rule, the control unit will be held by the person responsible for setting up the assembly device (10), or its maintenance, said assembly device (10) then being in an inaccessible location, or not being visible.

The radiofrequency tag (30) is of the standard type (RFID), passive, and includes an antenna tuned to a predetermined frequency connected to a chip containing an individual identification (ID) code. The radiofrequency tag (30) is part of the protruding tab (25), the mounting can be effected by welding, adhesion, heat transfer, duplicate molding, etc. According to a known method, a carrier signal received by the tag (30) from the control unit serves simultaneously as tag (30) power and interrogation signal. The tag then transmits a different carrier signal, amplitude-modulated by its individual ID code, for example.

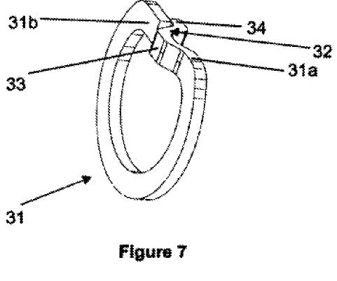

According to the invention, the outside rim (26) incorporates, by duplicate molding, a metallic element (31) configured as an open loop, for example in the form of a ring (FIG. 7). FIGS. 1 and 3 to 6 provide partial views of the assembly device (10) showing the clipping area of the cover (12) in partial cut-away to provide a detailed illustration of the metallic element (31) in its service positions. Thus positioned, the metallic element (31) is within the transmission-reception field of the antenna of the radiofrequency tag (30). Other forms of open loop may be considered for the metallic element (31) without deviating from the scope of the invention.

With reference to FIG. 7, the metallic element (31) is generally in a flat plane, but contains a bent portion (32) in one (31a) of its ends (31a, 31b). The bent portion (32) presents successively both a hollow area (33) and a tip (34) protruding from one side and the other, respectively, of the main plane of the metallic element (31). At rest, the tip (34) of the bent portion (32) is in contact with the other end (31b) of the metallic element (31).

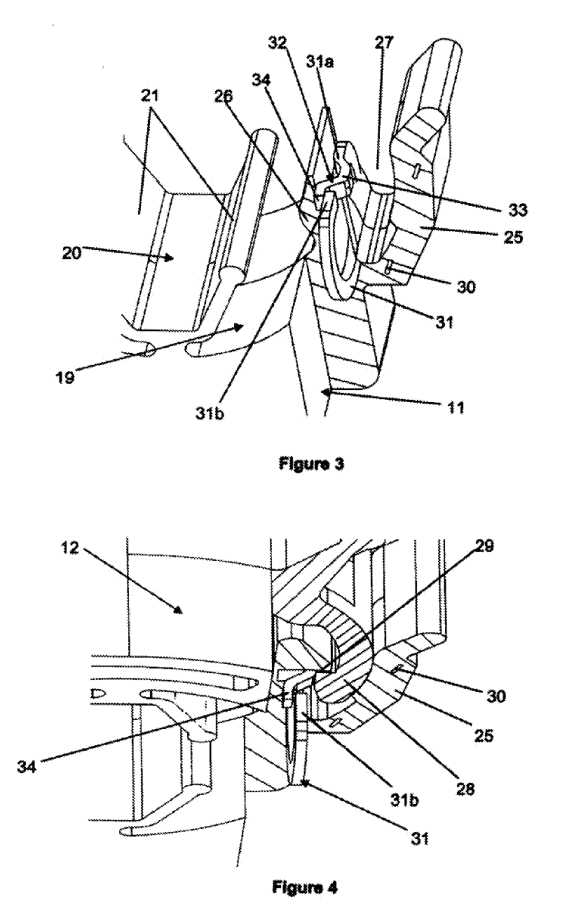

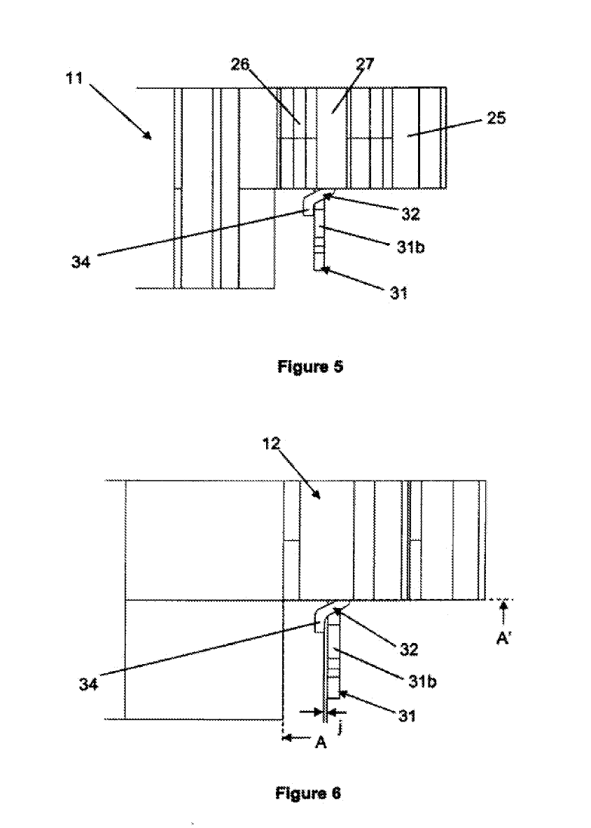

In FIGS. 3 and 5, the assembly device (10) is in the non assembled state. In this state, the metallic element (31) is at rest and is arranged in such a way that the hollow area (33) protrudes into the transverse slit (27) beneath the retaining face (29). The metallic element (31) constitutes a closed conductor and interferes with the transmission and/or reception of the antenna of the radiofrequency tag (30) according to the principles of a Faraday cage. Communications between the radiofrequency tag (30) and the control unit is impossible.

When the clipping hook (28) latches beneath the retaining face (29) in the previously described manner, the hook exerts pressure against the hollow area (33) of the metallic element (31), causing the latter to flex so that the tip portion (34) separates from the end (31b) of the metallic element (31), defining an area of clearance (j) (FIG. 6). In this position, the metallic element (31) is an open conductor and no longer interferes with the transmission and/or reception of the antenna of the radiofrequency tag (30), and communications between the radiofrequency tag (30) and the control unit become possible. When the control unit receives the carrier signal modulated by the ID code of the radiofrequency tag (30), it interprets it as indicating that the assembly device (10) is assembled. When more than one assembly device (10) are transmitting, the control unit is able to determine those that are assembled through the differences in modulation of the carrier signals it receives.

In other embodiments of assembly devices (10), the ends (31a, 31b) of the metallic element (31) are apart prior to assembly, and in contact after assembly. In this case, assembly of the device (10) by clipping the cover (12) to the base (11) causes the conductor constituted by the metallic element (31) to close. Communication between the assembly device (10) and the control unit is possible so long as the device (10) is not assembled, and impossible when it is in the assembled state. When the control unit receives the carrier signal modulated by the ID code of the radiofrequency tag (30), it interprets it as indicating that the assembly device (10) is not assembled.

To summarize, regardless of the embodiment considered, the metallic element (31) takes up a first position prior to assembly of the structural elements (support and tubes), and a second position after assembly, and the metallic element (31) interferes with the transmission and/or reception of the antenna of the radiofrequency tag (30) in one of the positions, and does not interfere with this transmission and/or reception in the other position.

When the metallic element (31) is fixed, as previously, the change in position of the metallic element (31) brought about by assembly of the assembly device (10) translates physically into a change in its configuration (open or closed conductor). In other embodiments, the metallic element (31) is mobile. In this case, the change in position of the metallic element (31) translates physically into a displacement of the metallic element (31). In some cases the metallic element (31) is respectively positioned in the transmission/reception field of the antenna of the radiofrequency tag (30) before assembly, and outside said field after assembly. In other cases, the metallic element (31) is positioned outside the transmission/reception field of the antenna of the radiofrequency tag (30) before assembly, and within said field after assembly.

Finally, it is clear that the assembly device (10) just described is only one particular, and in no way limiting, example of the invention, and that the invention can be adapted to any assembly device, such as, for example, devices for connecting tubular elements or devices for assembling plates.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-6. (canceled)

7. An assembly device for assembling two structural elements, said assembly device comprising:
a radiofrequency tag including an antenna for transmitting data concerning a status of the assembly to an external control unit; and
a metallic element disposed in a first position prior to assembly of the structural elements and in a second position after assembly, said metallic element interfering in one of said first and second positions with a transmission and/or reception of said antenna, and not interfering with a transmission and/or reception of said antenna in the other of said first and second positions.

8. The device of claim 7, wherein said metallic element is movable, said metallic element positioned within a transmission/reception field of said antenna in said first position, and positioned outside said field in said second position.

9. The device of claim 7, wherein said metallic element is movable, said metallic element positioned within a transmission/reception field of said antenna in said second position, and positioned outside said field in said first position.

10. The device of claim 7, wherein said metallic element is configured as a fixed open loop positioned within a transmission/reception field of said antenna, said metallic element having ends in contact with one another in said first position and apart from one another in said second position.

11. The device of claim 7, wherein said metallic element is configured as a fixed open loop positioned within a transmission/reception field of said antenna, said metallic element having ends in contact with one another in said second position and apart from one another in said first position.

12. The device of claim 10, wherein said ends are movable responsive to flexing of said metallic element.

13. The device of claim 11, wherein said ends are movable responsive to flexing of said metallic element.
